(19) United States
(12) Patent Application Publication
(10) Pub. No.: US 2006/0046146 A1
(43) Pub. Date: Mar. 2, 2006

(54) Method for producing non-expanded graphite powder

(75) Inventors: Nobuhiro Tsuji, Otsu City (JP); Hisanori Sugimoto, Otsu City (JP)

Correspondence Address: OLIFF & BERRIDGE, PLC, P.O. BOX 19928, ALEXANDRIA, VA, 22320, US

(73) Assignee: Nippon Graphite Industries Co., Ltd., Otsu City (JP)

(21) Appl. No.: 11/208,788

(22) Filed: Aug. 23, 2005

(30) Foreign Application Priority Data
Aug. 30, 2004 (JP) 2004-249584

(51) Int. Cl. H01M 4/62; H01M 4/50; C01B 31/04

(52) U.S. Cl. 429/232; 429/224; 423/448

(57) ABSTRACT

There is provided a new type of non-expanded graphite powder by peeling off a lamination plane within non-expanded graphite particles, which is useful as a conductive carbon material in a positive electrode mix for an alkaline manganese battery. The alkaline manganese battery has an excellent discharge property when the above non-expanded graphite powder are used as the conductive carbon material.

### BACKGROUND OF THE INVENTION

1. Field of the Invention

The present invention relates to a method for producing non-expanded graphite powder, a non-expanded graphite powder, a conductive carbon material, a positive electrode mix and an alkaline manganese battery, and more particularly to an improvement of the positive electrode mix for alkaline battery using manganese oxide as an active material of positive electrode.

2. Related Art

Small-sized portable electronic equipments such as a digital camera, PDA and the like are remarkably popularized nowadays, and hence it is increasingly demanded to improve a quality and a service life of primary batteries for these electronic equipments. Especially, it is strongly requested to develop a technique for improving performances, particularly service life of these batteries in pulse use from middle current to high current (generally 1000 mA to 2000 mA).

In an alkaline manganese battery, manganese dioxide is used as an active material of positive electrode, and carbon powder is used as a conductive substance. As the carbon powder is used a usual low bulk graphite powder or an expanded graphite powder.

In order to improve the quality of the alkaline manganese battery, especially the service life in the pulse use from the middle current to the high current, it is required that the content of manganese dioxide is increased in the positive electrode mix and the internal resistance of the battery is lowered and the battery contains the quantity of carbon powder enough to provide the sufficient conductive networks.

In general, as the quantity of manganese dioxide becomes large, the discharge capacity of the battery becomes high, but it is difficult to provide the sufficient conductive network. If it is intended to provide the sufficient conductive network by increasing the quantity of carbon powder, the quantity of manganese dioxide decreases and the discharge capacity reduces. The quantity of manganese dioxide that can be included in the positive electrode is limited to a certain degree through the quantity of carbon powder required to provide the sufficient conductive network.

In order to solve the above-mentioned problems, a high bulk expanded graphite powder or a mixture of high bulk expanded graphite powder and usual low bulk graphite powder is used in the conventional alkaline manganese battery (see JP-A-11-149927 and JP-A-9-35719).

### SUMMARY OF THE INVENTION

It is an object of the present invention to provide a non-expanded graphite powder as a new type of graphite powder having a reduced surface flaw. Also, it is an object of the present invention to provide an alkaline manganese battery in which such a non-expanded graphite powder is used in a positive electrode mix as a conductive carbon material and the discharge capacity and conductive network are satisfied but also the discharge property in pulse use from middle current to high current is good.

The present invention lies in a method for producing a non-expanded graphite powder from non-expanded graphite particles, which comprises a step of peeling off a lamination plane within the non-expanded graphite particles.

Also, the present invention is concerned with a non-expanded graphite powder obtained by peeling off a lamination plane within non-expanded graphite particles.

Furthermore, the present invention is concerned with a conductive carbon material made from graphite powders containing a non-expanded graphite powder obtained by peeling off a lamination plane within non-expanded graphite particles.

Moreover, the present invention is concerned with a positive electrode mix for alkaline battery comprising manganese dioxide and a conductive carbon material as a main constitutional material wherein a non-expanded graphite powder obtained by peeling off a lamination plane within non-expanding graphite particles and grinding is used as the conductive carbon material and said non-expanded graphite powder have an average particle size of 1.0-40.0 μm, an apparent density of 0.02-0.12 g/cm³ and a specific surface area of 2.0-8.0 m²/g.

Also, the present invention is concerned with a positive electrode mix in which the conductive carbon material contains 20-80% by weight of the non-expanded graphite powder, or a positive electrode mix in which the conductive carbon material contains a usual low bulk graphite powder or an expanded graphite powder, or a positive electrode mix containing 98-92 parts by weight of manganese dioxide and 2-8 parts by weight of the conductive carbon material.

Further, the present invention is concerned with an alkaline manganese battery comprising a positive electrode made from a positive electrode mix comprising manganese dioxide and a conductive carbon material as a main constitutional material wherein a non-expanded graphite powder obtained by peeling off a lamination plane within non-expanding graphite particles and grinding is used as the conductive carbon material and said non-expanded graphite powder have an average particle size of 1.0-40.0 μm, an apparent density of 0.02-0.12 g/cm³ and a specific surface area of 2.0-8.0 m²/g.

### BEST MODE FOR CARRYING OUT THE INVENTION

According to the present invention, no significant burden is applied to the environment because the expanded graphite particle treated with strong acid or strong oxidizing agent is not used in the production of the non-expanded graphite powder. Also, according to the present invention, the resulting non-expanded graphite powder have an apparent density equal to that of the expanded graphite powder, and are fewer in the flaw on the surface of the powdered particle or clean in the surface of the powdered particle and small in the specific surface area.

The non-expanded graphite powder are useful as a conductive carbon material. When the non-expanded graphite powder are used as a conductive carbon material of a positive electrode mix for an alkaline battery, the number of graphite powders per unit weight is increased as compared with the usual low bulk graphite powder (which is big likewise the expanded graphite powder), and the non-expanded graphite powder are uniformly mixed with manganese dioxide in a short time to form the conductive network in the overall positive electrode mix, and hence the energy of manganese dioxide is equally and efficiently utilized to improve the availability of manganese dioxide.

Also, the non-expanded graphite powder are fewer in the flaw on the surface of powdered particle as compared with the usual low bulk graphite powder and expanded graphite powder, and are clean (that is, the specific surface area is small) and very good in the contact with manganese dioxide, and as a result, the performance of the alkaline manganese battery in pulse discharge from middle current to high current is improved and the discharge property after the long-term storage is considerably improved.

The usual graphite powder are obtained by randomly grinding natural graphite or synthesized graphite by means of a grinding machine such as a hammer mill, a jet mill or the like, and are low bulk. In general, the low bulk graphite powder have a characteristic that as the particle size becomes small, the apparent density becomes low and the specific surface area becomes large.

As a result of the inventors' studies, it has been found that the usual graphite powder obtained by the above procedure become larger in the specific surface area due to the fact that each of powdered particles is small but also there are numerous flaws in the surface of the powdered particle. These flaws cause a stress to the conductivity when being mixed with manganese dioxide as an active material of the positive electrode and have a significantly adverse affect on the discharge property of the alkaline manganese battery.

The expanded graphite powder is obtained by chemically treating the usual flake graphite or the like with a strong acid such as concentrated sulfuric acid or the like and a strong oxidizing agent such as hydrogen peroxide or the like, superheating to a high temperature and then grinding with the above-mentioned grinding machine. Such an expanded graphite powder have a characteristic that the apparent density is low even though the particle size is large.

The inventors have found that the expanded graphite powder make the specific surface area larger due to the flaws or the like as compared with the usual graphite powder, and do not provide a satisfactory discharge property when being mixed and used with manganese dioxide.

The present invention is based on the discovery that the non-expanded graphite powder obtained by peeling off a lamination plane within non-expanding graphite particles and grinding increase a filling quantity of manganese dioxide as an active substance for the positive electrode of the alkaline manganese battery and lower the internal resistance of the battery to make the discharge capacity large, and can provide whereby and the powders can provide an alkaline manganese battery having an excellent discharge characteristic, particularly an excellent pulse discharge from middle current to high current without obstructing the conductive network.

The non-expanded graphite powder are obtained by applying a force to the lamination plane of the natural or synthesized graphite particles from a direction parallel thereto to peel off the lamination plane and then grinding. In order to peel off the lamination plane of the graphite particles, the force from the direction parallel to lamination plane is used and such a force is applied to the lamination plane in the parallel direction, whereby the lamination plane can be peeled off. The powder treatment of the graphite particle can be conducted by peeling off the lamination plane and grinding.

The non-expanded graphite powder are a newly third type of graphite powder different from the usual low bulk graphite powder or high bulk expanded graphite powder. The non-expanded graphite powder are high bulk and low in the apparent density even though the particle size is large. Also, the non-expanded graphite powder have a characteristic that the surface of powdered particle is fewer in the flaw and clean, and the specific surface area thereof is small. In Tables 1 and 2 are shown the natures of the non-expanded graphite powder, usual graphite powder and expanded graphite powder.

TABLE 1
Product having an average particle size of 10 μm

| | Graphite Powders | | |
|---|---|---|---|
| | Non-expanded | Usual graphite | Expanded |
| | graphite powder | powder | graphite powder |
| Apparent density | 0.04 | 0.12 | 0.06 |
| (g/cm³) | | | |
| Specific surface | 6.3 | 12.4 | 18.6 |
| area (m²/g) | | | |

TABLE 2
Products having an average particle size of 20 μm

| | Graphite Powders | | |
|---|---|---|---|
| | Non-expanded | Usual graphite | Expanded |
| | graphite powder | powder | graphite powder |
| Apparent density | 0.08 | 0.18 | 0.10 |
| (g/cm³) | | | |
| Specific surface | 4.2 | 7.6 | 12.3 |
| area (m²/g) | | | |

The conventionally used usual low bulk graphite powder are relatively small in the specific surface area but is large in the apparent density. Therefore, when such a usual graphite powder is used in the positive electrode mix for the alkaline manganese battery, the number of graphite particles per unit weight is reduced, and hence the conductive network is not formed in a region having a less content of graphite powder and the availability of manganese dioxide is considerably degraded. Also, the usual graphite powder have many flaws on the surface and the contact with manganese dioxide is deteriorated by such flaws, and hence the discharge property after the long-term storage becomes extremely bad.

The expanded graphite powder are preferable in a point that the apparent density is low and the number of graphite particles per unit weight is large. However, the specific surface area is increased due to the flaws as compared with the usual graphite powder to degrade the contact with manganese dioxide, and the discharge property after the long-term storage is bad. Also, the expanded graphite powder are not preferable from a viewpoint of the environment because it is required to use the strong acid or strong oxidizing agent in the production. Further, the expanded graphite powder are high in the cost.

On the contrary, the non-expanded graphite powder according to the present invention are preferable to have an average particle size of 1.0-40.0 μm, an apparent density of 0.02-0.12 g/cm³ and a specific surface area of 2.0-8.0 m 2/g. Such non-expanded graphite powder are useful as a conductive material, particularly a conductive carbon material in a positive electrode mix for an alkaline manganese battery.

When the average particle size of the non-expanded graphite powder exceeds 40 μm, the average particle size of the non-expanded graphite powders as a conductive carbon material becomes larger than the particle size of manganese dioxide as an active substance for the positive electrode, so that the energy of manganese dioxide cannot be utilized equally and efficiently, and the service life of the battery may be lowered.

When the average particle size of the non-expanded graphite powder is less than 1.0 μm, it tends to hardly form the positive electrode mix. Also, the mass production of the non-expanded graphite powder having an average particle size of less than 1.0 μm tends to become difficult industrially. Even if the non-expanded graphite powder having an average particle size of less than 1.0 μm could be mass-produced industrially, there is a possibility that such non-expanded graphite powder become extremely high in the cost.

There is a considerable correlation between average particle size and apparent density in the non-expanded graphite powder. As the average particle size of the non-expanded graphite powder becomes small, the apparent density becomes low. In the actual production, the apparent density of the non-expanded graphite powder is often within a range of 0.02-0.12 g/cm³.

Also, there is a considerable correlation between average particle size and specific surface area in the non-expanded graphite powder. As the average particle size of the non-expanded graphite powder becomes small, the specific surface area becomes large. In the actual production, the specific surface area of the non-expanded graphite powder is often within a range of 2.0-8.0 m²/g.

Preferably, the non-expanded graphite powder have an average particle size of 1.0-20 μm, an apparent density of 0.02-0.08 g/cm³ and a specific surface area of 4.0-8.0 m²/g. Such non-expanded graphite powder provide the more stable discharge property in the positive electrode of the alkaline manganese battery.

The non-expanded graphite powder can be produced by using non-expanded graphite particles as a raw material. The non-expanded graphite particles are graphite particles not expanded with a strong acid or a strong oxidizing agent. The graphite particles are available by usual way. As to the graphite particle, the particle size, shape and the like are not particularly limited, and various natural graphite and synthesized (artificial) graphites can be used. The usable raw material may include two or more types of graphite particles.

In the non-expanded graphite powder, the particle size, apparent density and specific surface area can be set variously. These values can be determined by using various measuring methods and devices. The above predetermined values of the particle size, apparent density and specific surface area are a value of particle size measured by a laser diffraction type particle size distribution measuring device made by Nikkiso Co., Ltd., Japan, a value of apparent density measured according to JIS Z-2504, and a value of specific surface area measured by a nitrogen adsorption method, respectively.

When the non-expanded graphite powder are used as a conductive material, they can be used in combination with at least one conductive material selected from the group consisting of usual graphite powder, expanded graphite powder and the like. In this case, it is preferable that the quantity of the non-expanded graphite powder per the total weight of the conductive material is not less than 20% by weight, for example, 20-80% by weight, more preferably not less than 50% by weight, for example, 50-80% by weight, in view of the improvement on the discharge property of the alkaline manganese battery.

It is preferable that the positive electrode mix consists of 98-92 parts by weight of the active substance for the positive electrode such as manganese dioxide and 2-8 parts by weight of the conductive material. When the quantity of the conductive material to the active substance for the positive electrode is less than 2 parts by weight, the number of the non-expanded graphite powder as the conductive material is decreased, so that the adequate conductive network may not be formed, and hence there is a fear of degrading the service life of the battery. While, when the quantity of the conductive material to the active substance for the positive electrode exceeds 8 parts by weight, the quantity of the active substance for the positive electrode is decreased in the positive electrode mix, and hence a tendency of degrading the service life of the battery appears.

The present invention will be explained concretely with reference to examples and comparative examples. The following examples are given in illustration of the present invention and are not intended as limitations thereof.

### EXAMPLE 1

A positive electrode mix is prepared by using a non-expanded graphite powder having a given particle size as a conductive carbon material. This positive electrode mix is shaped into a ring-like positive electrode to produce an alkaline manganese battery.

Concretely, 5% by weight of the non-expanded graphite powder having an average particle size of 10 μm, an apparent density of 0.04 g/cm³ and a specific surface area of 6.3 m² μg is uniformly mixed with 95% by weight of manganese dioxide. To the mixture is spray-added an electrolyte (aqueous solution of 9 M potassium hydroxide), which is compressed and dressed to produce a positive electrode mix. This positive electrode mix is shaped into a ring. This ring is used as a positive electrode to produce a LR6 type alkaline manganese battery.

### EXAMPLE 2

A LR6 type alkaline manganese battery is produced in the same manner as in Example 1 except that 5% by weight of a non-expanded graphite powder having an average particle size of 20 μm, an apparent density of 0.08 g/cm³ and a specific surface area of 4.2 m²/g is used instead of the non-expanded graphite powder of Example 1.

### EXAMPLE 3

A LR6 type alkaline manganese battery is produced in the same manner as in Example 1 except that the quantity of the non-expanded graphite powders of Example 1 is changed to 2.5% by weight and 3.5% by weight of usual graphite powder having an average particle size of 10 μm, an apparent density of 0.12 g/cm³ and a specific surface area of 12.4 m²/g is further added so as to uniformly mix 6% by weight of the conductive carbon material and 94% by weight of manganese dioxide as a whole.

### EXAMPLE 4

A LR6 type alkaline manganese battery is produced in the same manner as in Example 2 except that the quantity of the non-expanded graphite powder of Example 2 is changed to 3.0% by weight and 3.0% by weight of an expanded graphite powder having an average particle size of 18 μm, an apparent density of 0.10 g/cm³ and a specific surface area of 14.3 m²/g is further added so as to uniformly mix 6% by weight of the conductive carbon material and 94% by weight of manganese dioxide as a whole.

### COMPARATIVE EXAMPLE 1

A LR6 type alkaline manganese battery is produced in the same manner as in Example 1 except that 5% by weight of usual graphite powder having an average particle size of 10 μm, an apparent density of 0.12 g/cm³ and a specific surface area of 12.4 m²/g is used instead of the non-expanded graphite powder of Example 1.

### COMPARATIVE EXAMPLE 2

A LR6 type alkaline manganese battery is produced in the same manner as in Example 1 except that 5% by weight of an expanded graphite powder having an average particle size of 10 μm, an apparent density of 0.06 g/cm³ and a specific surface area of 18.6 m²/g is used instead of the non-expanded graphite powder of Example 1.

### COMPARATIVE EXAMPLE 3

A LR6 type alkaline manganese battery is produced in the same manner as in Comparative Example 1 except that the quantity of the usual graphite powder in Comparative Example 1 is changed to 2.5 wt %, and 2.5% by weight of an expanded graphite powder in Comparative Example 2 is further added so as to uniformly mix 5% by weight of the conductive carbon material and 95% by weight of manganese dioxide as a whole.

The discharge property is measured with respect to each of the alkaline manganese batteries of Examples 1-4 and Comparative Examples 1-3. The discharge property is evaluated as a total time of adequate discharge. The results are shown in Table 3. In Table 3, each measured value is represented by a relative value when the measured value of Comparative Example 2 is 100. In this case, the discharge property is evaluated in each of the following discharge conditions (I)-(III).
(I) Initial voltage: about 1.6 V, load resistance: 3.9 Ω, continuous discharge, final voltage: 0.9 V,
(II) Initial voltage: about 1.6 V, pulse discharge of 1000 mA, 10 min/hour, final voltage: 1.0 V.

(III) Initial voltage: about 1.6 V, pulse discharge of 1000 mA, 10 sec/min, 1 hour/day, final voltage: 1.0 V.

TABLE 3

| | | Discharge Conditions | | |
|---|---|---|---|---|
| | | I | II | III |
| Examples | 1 | 117 | 138 | 129 |
| | 2 | 106 | 123 | 119 |
| | 3 | 110 | 118 | 119 |
| | 4 | 105 | 110 | 107 |
| Comparative | 1 | 97 | 95 | 92 |
| Examples | 2 | 100 | 100 | 100 |
| | 3 | 100 | 99 | 97 |

As seen from the results of Table 3, the alkaline manganese batteries of Examples 1-4 are remarkably excellent in the discharge property as compared with the batteries of Comparative Examples 1-3. Particularly, the alkaline manganese battery according to the present invention considerably improves the service life in pulse discharge from middle current to high current. Also, as seen from the results of Examples 3 and 4, it is recognized that the discharge property is largely improved even when the non-expanded graphite powder are mixed with the usual graphite powder or expanded graphite powder in use.

As mentioned above, according to the present invention, the non-expanded graphite powder useful as a conductive material can be obtained, and also the alkaline manganese battery can be provided by using such a non-expanded graphite powder as a conductive carbon material in a positive electrode mix. This alkaline manganese battery is extremely large in the discharge capacity as compared with the use of the conventional usual graphite powder or expanded graphite powder and has an excellent discharge property, especially an improved usage performance in pulse discharge from middle current to high current.

1. A method for producing a non-expanded graphite powder from non-expanded graphite particles, which comprises a step of peeling off a lamination plane within the non-expanded graphite particles.

2. A non-expanded graphite powder obtained by peeling off a lamination plane within non-expanded graphite particles.

3. A conductive carbon material made from graphite powders containing a non-expanded graphite powder obtained by peeling off a lamination plane within non-expanded graphite particles.

4. A positive electrode mix for an alkaline battery comprising manganese dioxide and a conductive carbon material as a main constitutional material wherein a non-expanded graphite powder obtained by peeling off a lamination plane within non-expanding graphite particles and grinding is used as the conductive carbon material and said non-expanded graphite powder have an average particle size of 1.0-40.0 μm, an apparent density of 0.02-0.12 g/cm³ and a specific surface area of 2.0-8.0 m²/g.

5. A positive electrode mix according to claim 4, wherein the conductive carbon material contains 20-80% by weight of the non-expanded graphite powder.

6. A positive electrode mix according to claim 5, wherein the conductive carbon material contains a usual low bulk graphite powder or an expanded graphite powder.

7. A positive electrode mix according to claim 4, which contains 98-92 parts by weight of manganese dioxide and 2-8 parts by weight of the conductive carbon material.

8. An alkaline manganese battery comprising a positive electrode made from a positive electrode mix comprising manganese dioxide and a conductive carbon material as a main constitutional material wherein a non-expanded graphite powder obtained by peeling off a lamination plane within non-expanding graphite particles and grinding is used as the conductive carbon material and said non-expanded graphite powder have an average particle size of 1.0-40.0 μm, an apparent density of 0.02-0.12 g/cm³ and a specific surface area of 2.0-8.0 m²/g.

9. A positive electrode mix according to claim 5, which contains 98-92 parts by weight of manganese dioxide and 2-8 parts by weight of the conductive carbon material.

10. A positive electrode mix according to claim 6, which contains 98-92 parts by weight of manganese dioxide and 2-8 parts by weight of the conductive carbon material.
